(19) United States
(12) Patent Application Publication
(10) Pub. No.: US 2008/0256252 A1
(43) Pub. Date: Oct. 16, 2008

(54) SERVER APPARATUS, CONTENT PROCESSING METHOD THEREFOR, CONTENT PROCESSING PROGRAM THEREFOR, SERVER SYSTEM AND RECORDING MEDIUM

(75) Inventor: Kazuo Tomono, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/928,906

(22) Filed: Oct. 30, 2007

(30) Foreign Application Priority Data
Oct. 31, 2006 (JP) 2006-296598

(51) Int. Cl. G06F 15/16

(52) U.S. Cl. 709/230

(57) ABSTRACT

The present invention relates to a server apparatus that provides content to Web sites, and is directed to dynamically disperse accesses. A server apparatus that receives accesses from a plurality of client apparatuses and responds to the accesses, configured to include a processing unit that monitors accesses of the client apparatuses and, when accesses concentrate, creates second content correlated with first content on which the accesses concentrate for the first content, and to disperse accesses that concentrate on the first content to the second content.

### CROSS-REFERENCE TO RELATED APPLICATIONS

This application is based upon and claims the benefit of priority from the prior Japanese Patent Application No. 2006-296598, filed on Oct. 31, 2006, the entire contents of which are incorporated herein by reference.

### BACKGROUND OF THE INVENTION

1. Field of the Invention

The present invention relates generally to a responding process of a server apparatus to accesses from a plurality of client apparatuses, and more particularly, to a server apparatus, a content processing method therefor, a content processing program therefor, a computer-readable recording medium having thereon stored a content processing program therefor and a server system that execute the responding process that copes with concentration of accesses from client apparatuses.

2. Description of the Related Art

Conventionally, many Web (World Wide Web) sites have been opened on computer networks. A Web site is configured on a computer (a server apparatus) that provides services and receives accesses from many client apparatuses that connect to computer networks. An access of a client apparatus to a Web site depends on information and services provided from the Web site and the number of accesses differs depending on the need and the degree of popularity, etc., on the client side. When accesses concentrate on a server apparatus, it can be expected that responding processes to the accesses take a long time and transfer of content requested by the clients is hindered. The processing capacity of the server apparatus is limited.

Regarding the processes in a sever that receives a plurality of accesses as above, Japanese Patent Application Laid-Open Publication No. 11-025059 discloses monitoring the load factor of a CPU (Central Processing Unit) of a server, extracting servers that are overloaded and servers that are under-loaded, collecting the size of particular content of an overloaded server and the number of users of each of the overloaded servers and the under-loaded servers, hiding the name of the content from a menu list for the overloaded servers, duplicating the name of the content and the content from the overloaded servers for the under-loaded servers, and presenting the name of the content and the content to the users (abstract, FIG. 1, etc.).

Japanese Patent Application Laid-Open Publication No. 2002-215447 discloses: counting the number of times a client terminal has made accesses; in the case where the number of accesses has exceeded the maximal number of accesses within a predetermined time period when a client terminal makes an accesses, creating an HTML (Hyper Text Markup Language) document in response to this situation; in the case where the number of accesses is equal to or fewer than the maximal number of accesses, creating an HTML document in response to this situation; sending data thereof; and being able to view the data at the client terminal. This '447 application also discloses that, when accesses concentrate during a certain time period, the data volume is reduced by deleting a portion of process information from the HTML document to be displayed on a WWW (World Wide Web) browser (abstract, FIG. 3, paragraph numbers 0029, 0030, 0031, etc.).

Because the processing capacity of a server apparatus is limited, a problem has arisen that displaying the content needs time, is impossible, etc., when accesses from many clients concentrate. To avoid such a situation, the server apparatus suppresses accesses by displaying error messages and, when the concentration of accesses can not be avoided still, the site itself must be closed.

With such server processing, for a site for selling articles, occurrence of faults such as taking time to display the content thereof, disability of displaying the content thereof, etc., degrade the quality of the services thereof and, therefore, shopping is hindered or shopping eagerness is impaired even when accesses are made with efforts. Therefore, this situation should be avoided and stable provision of services is indispensable.

Japanese Patent Application Laid-Open Publication Nos. 11-025059 and 2002-215447 have no disclosure and no suggestion regarding the above problems and no disclosure and no suggestion of any configuration to solve the problems.

### SUMMARY OF THE INVENTION

The object of the present invention is, relating to a server apparatus that provides content to Web sites, to disperse dynamically accesses.

Describing the object in detail, the object is to disperse the accesses corresponding to the trend of the accesses in response to occurrences of access concentration.

Another object of the present invention is, relating to a server apparatus that provides content to Web sites, to give easing to the processing of a server by dispersing accesses.

Another object of the present invention, relating to a server apparatus that provides content to Web sites, to expedite responding processes to client apparatuses.

Another object of the present invention, relating to a server apparatus that provides content to Web sites, to facilitate various deployments of the content in response to access concentration.

To achieve the above objects, the present invention facilitates dispersion of access concentration by: monitoring concentration of accesses from client apparatuses to the content provided by a server apparatus; and, when accesses concentrate, creating new content that is correlated with the content on which accesses have concentrated. Concerning the former content and the latter content, for example, another piece of content consisting of a content portion in the former content, another piece of content including the content portion, or another piece of content excluding the content portion may be created. As a result, the processing is suppressed to the extend under the processing capacity of the server apparatus and processing is eased and, therefore, expediting of the responding processes to the client apparatuses can be facilitated. Because deployment of various pieces of content is enabled by access concentration, provision of services coping with access concentration is enabled. Therefore, the above objects can be achieved.

In order to attain the above objects, according to a first aspect of the present invention there is provided a server apparatus that receives accesses from a plurality of client apparatuses and responds to the accesses, comprising a processing unit that monitors accesses from the client apparatuses and, in case where accesses concentrate on first content, creates second content for the first content, the second content being correlated with first content, wherein the server apparatus disperses the accesses that concentrate on the first content to the second content.

To attain the above objects, in the server apparatus, the second content may be content consisting only of a particular content portion of the first content, content including the particular content portion, or content excluding the particular content portion. The content portion in the second content may be changed into a form that is different from the first content. The processing unit may have a function of creating and/or editing the first content and/or the second content. The second content may include a particular content portion divided from the first content. The second content may display using character information a content portion including image included in the first content. The second content may shrink and display a particular content portion included in the first content. The processing unit may monitor concentration of accesses on or the trend of accesses to one or more content portion(s) included in the first content, extract a content portion on which accesses highly concentrate, and create the second content including the extracted content portion. The first content and/or the second content may include character information and/or video information. The first content and/or the second content may be display information for the client apparatuses. The processing unit may comprise a storing unit that stores the plurality pieces of second contents prepared in advance and select the second content from the storing unit.

To attain the above objects, according to a second aspect of the present invention there is provided a content processing method for a server apparatus that receives accesses from a plurality of client apparatuses and responds to the accesses, the method comprising the steps of monitoring accesses of the client apparatuses; and in case where accesses concentrate on first content, creating second content correlated with the first content.

To attain the above objects, the content processing method for a server apparatus may further comprise the step of changing the second content to a form that is different from that of the first content. In the content processing method for a server apparatus, processing of the second content may comprise the step of creating shrunk display information of a particular content portion included in the first content. The content processing method for a server apparatus may further comprise the steps of monitoring concentration of accesses on or the trend of accesses to one or more content portion(s) included in the first content; extracting a content portion on which accesses highly concentrate; and creating the second content including the extracted content portion. The content processing method for a server apparatus may further comprise the steps of preparing in advance the plurality pieces of second contents; and selecting the second content.

To attain the above objects, according to a third aspect of the present invention there is provided a content processing program that is executed by a computer and is for a server apparatus that receives accesses from a plurality of client apparatuses and responds to the accesses, the program comprising the steps of monitoring accesses of the client apparatuses; and in case where accesses concentrate on first content, creating second content correlated with the first content.

To attain the above objects, the content processing program for a server apparatus may further comprise the step of changing the second content to a form that is different from that of the first content. In the content processing program for a server apparatus, processing of the second content may comprise the step of creating shrunk display information of a particular content portion included in the first content. The content processing program for a server apparatus may further comprise the steps of monitoring concentration of accesses on or the trend of accesses to one or more content portion(s) included in the first content; extracting a content portion on which accesses highly concentrate; and creating the second content including the extracted content portion. The content processing program for a server apparatus may further comprise the steps of preparing in advance the plurality pieces of second contents; and selecting the second content.

To attain the above objects, according to a fourth aspect of the present invention there is provided a server system including a server apparatus that receives accesses from a plurality of client apparatuses and responds to the accesses, the system comprising a server apparatus comprising a processing unit that monitors accesses from the client apparatuses and, in case where accesses concentrate on first content, creates second content correlated with the first content, the server apparatus dispersing the accesses that concentrate on the first content to the second content.

To attain the above objects, in the server system, the server apparatus may monitor concentration of accesses on or the trend of accesses to one or more content portion(s) included in the first content, extract a content portion on which accesses highly concentrate, and create the second content including the extracted content portion.

To attain the above objects, according to a fourth aspect of the present invention there is provided a computer-readable recording medium having thereon stored a content processing program for a server apparatus that receives accesses from a plurality of client apparatuses and responds to the accesses, the program comprising the steps of monitoring accesses of the client apparatuses; and in case where accesses concentrate on first content, creating second content for the first content, the second content being correlated with the first content.

Features and advantages of the present invention are listed as follows.

(1) Accesses from the client apparatuses are monitored and, when accesses concentrate, the second content is created that are correlated with the first content on which the accesses concentrate. Therefore, the concentration of the accesses on the first content can be dispersed to the second content and, due to the dispersion of the accesses, the load on the server apparatus can be alleviated and the processing thereof can be eased.

(2)Expedition of the responding processes of the server apparatus to the client apparatuses can be facilitated.

(3) Because the content portion extracted from the first content can be deployed as the second content, the original content can be developed to many content versions having rich variation and the concentration of the accesses can be suppressed.

Other objects, features, and advantages of the present invention will be more clear by referencing the accompanying drawings and embodiments.

### BRIEF DESCRIPTION OF THE DRAWINGS

FIG. 1 depicts an exemplary server system according to a first embodiment;

FIG. 2 depicts a flowchart of an exemplary process procedure of a content processing method;

FIG. 3 depicts an updating process of a Web page and a creating process of a new Web page;

FIG. 4 depicts an updating process of a Web page and a creating process of a new Web page;

FIG. 5 depicts a block diagram of an exemplary server apparatus;

FIG. 6 depicts exemplary stored content in a hard disk apparatus in a storing unit;

FIG. 7 depicts a block diagram of an exemplary client apparatus;

FIG. 8 depicts a flowchart concerning a process procedure of a server system;

FIG. 9 depicts a flowchart of an exemplary process procedure of a content processing method and a content processing program;

FIGS. 10A and 10B depict an example of editing and creating of a Web page corresponding to the content processing;

FIG. 11 depicts an example of editing and creating of a Web page corresponding to the content processing;

FIG. 12 depicts an example of editing and creating of a Web page corresponding to the content processing;

FIG. 13 depicts a flowchart of an exemplary process procedure of a content processing method and a content processing program according to a second embodiment;

FIGS. 14A and 14B depict exemplary content processing;

FIGS. 15A and 15B depicts exemplary content processing;

FIG. 16 depicts a flowchart of an exemplary process procedure of a content processing method and a content processing program according to a third embodiment;

FIG. 17 depicts exemplary content processing;

FIG. 18 depicts a flowchart of an exemplary process procedure of a content processing method and a content processing program according to a fourth embodiment; and

FIG. 19 depicts exemplary content processing for article retrieval.

### DETAILED DESCRIPTION OF THE PREFERRED EMBODIMENTS

### First Embodiment

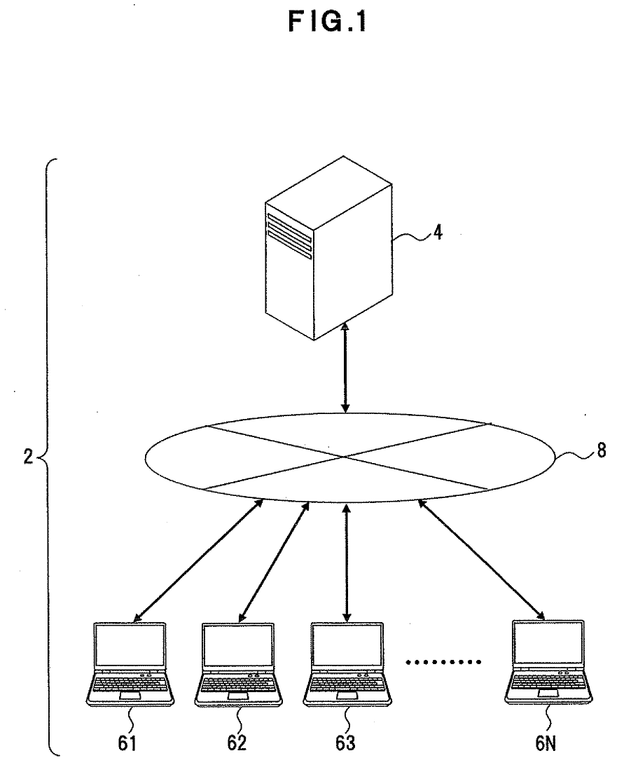

Description will be given for a server system according to a first embodiment of the present invention referring to FIG. 1. FIG. 1 depicts an exemplary server system according to the first embodiment.

This server system 2 is configured by connecting a server apparatus 4 that provides content and a plurality of client apparatuses 61, 62, . . . , 6N that receive provision of content from the server apparatus 4 through a network 8. The content is up on a Web site and is information, programs, etc., that is made viewable or executable according to requests for viewing, etc., conveyed by the accesses when the server apparatus receives accesses from the client apparatuses 61, 62, . . . , 6N. The Web site constitutes, for example, a so-called “shopping site” for selling articles. The server apparatus 4 is, for example, a computer having a communication function and opens Web sites that are accessible from the client apparatuses 61, 62, . . . , 6N on the network 8. The client apparatuses 61, 62, . . . , 6N are, for example, computers each having a communicating function that enables communication with the server apparatus 4, and are composed of, for example, PCs (Personal Computers), portable telephones terminal apparatuses, PDAs (Personal Digital Assistants), etc. The network 8 constitutes, for example, a network environment such as the Internet.

In the above server system 2, when accesses from the client apparatuses 61, 62, . . . , 6N concentrate on the content to be provided from the server apparatus 4, the load on the server apparatus 4 is increased and responses from the server apparatus 4 to the client apparatuses 61, 62, . . . , 6N are delayed in proportion to the degree of the concentration. In the server system 2, the server apparatus 4 monitors accesses from the client apparatuses 61, 62, . . . , 6N and creates, for first content as content on which accesses concentrate, second content as content correlated with the first content. That is, coping with the case where accesses concentrate on the first content, single piece or a plurality pieces of second content is/are dynamically created. When the second content is content consisting only of a particular content portion of the first content, content including the particular content portion, or content excluding the particular content portion, the accesses concentrating on the first content can be dispersed to the second content.

The monitoring of accesses by the server apparatus 4, for example, can be executed by referring to an access log and the load on the server can be monitored using the reference. The first content is, for example, pages carrying many articles. The second content is content including a particular content portion of the first content. When accesses to the first content concentrate, the second content is dynamically created. That is, the second content is configured to guide accesses from the first content to the second content. The second content consists of, for example, a page as means to disperse accesses, pages dedicated to articles, etc.

According to the above configuration, for the accesses that concentrate on the first content, accesses to the first content are dispersed to the second content and the concentration of accesses to the first content is alleviated because another piece of content consisting only of a particular content portion from the first content, another piece of content including the particular content portion, or another piece of content excluding the particular content portion is created as the second content from the first content.

Applying the above server system 2 to a particular shopping site, in the case where accesses concentrate on particular pages carrying hot items, featured items, etc., when a portion of a plurality of hot items and featured items is extracted from those items and other pages carrying the portion are created, dispersion of the accesses can be facilitated. Inconvenience caused by the concentration of accesses such as the case where the content can not be displayed, it takes time to display, and error pages are displayed due to limiting of accesses can be avoided, and the server system 2 contributes to improvement of the efficiency of displaying the content and selling and buying of articles.

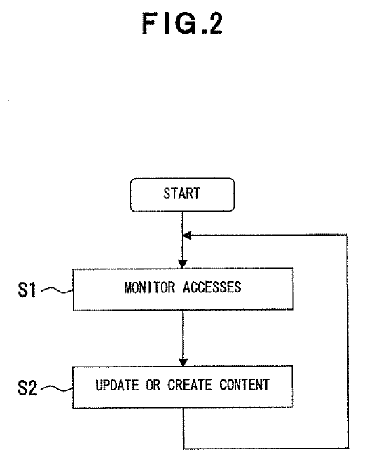

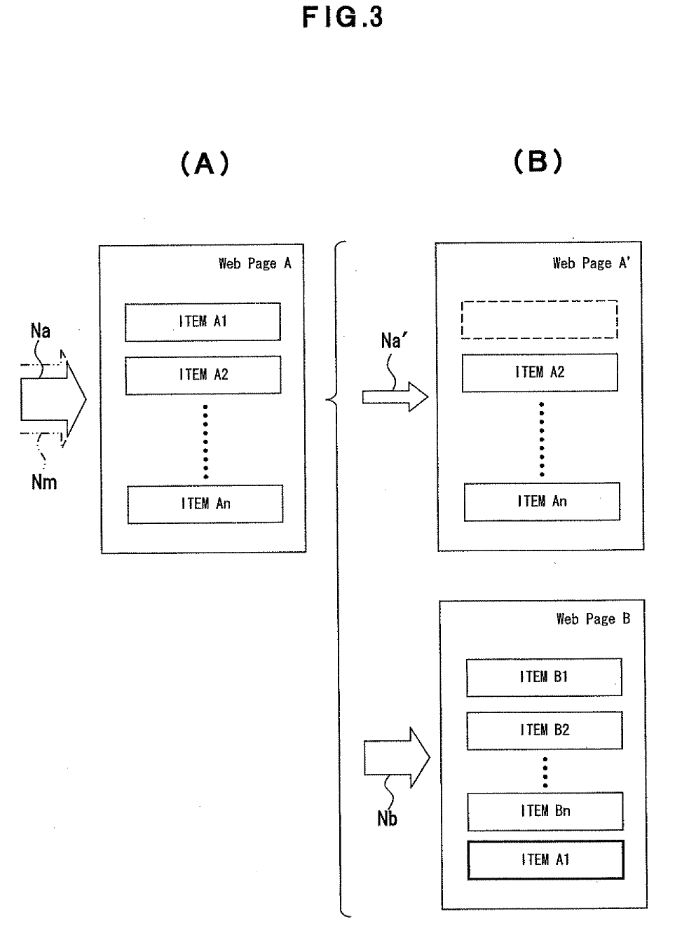

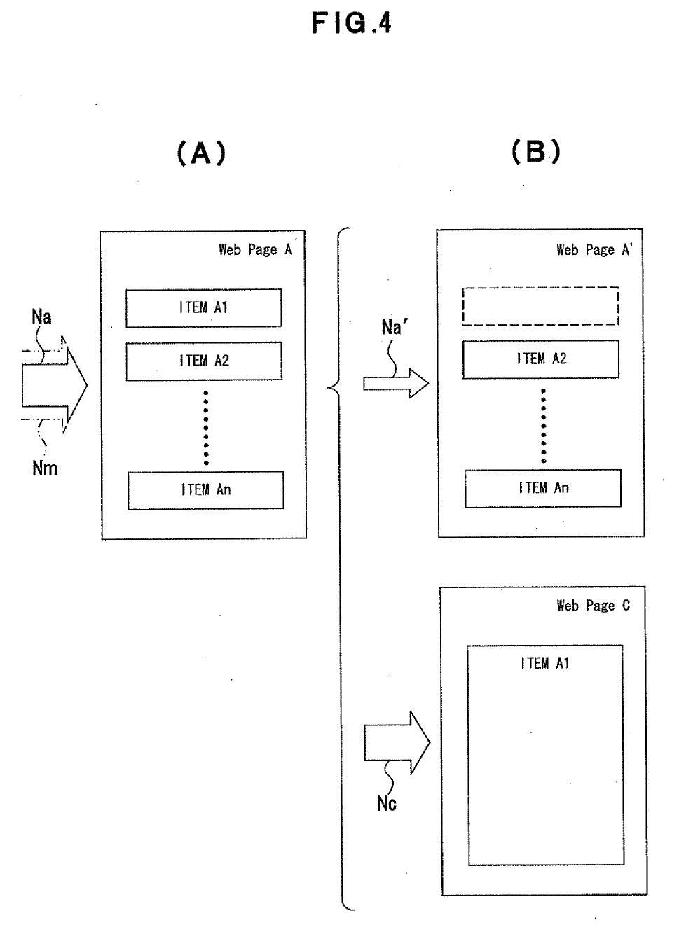

Description will be given for a content processing method in the server system 2 referring to FIGS. 2, 3 and 4. FIG. 2 depicts a flowchart of an exemplary process procedure of a content processing method. FIGS. 3 and 4 depict an updating process of a Web page and a creating process of a new Web page. In FIGS. 3 and 4, same reference numerals are respectively given to the same components.

According to the content processing method, the server apparatus 4 monitors accesses from the plurality of client apparatuses 61 to 6N (step S1), when accesses concentrate, creates dynamically new content (step S2), and disperses the accesses. The content processing method includes the following process procedure.

### 1. Monitoring Process of Accesses

The monitoring of accesses is executed to identify concentration of accesses from the client apparatuses 61, 62, . . . , 6N, and the content on which accesses concentrate. In this case, the number of accesses to a Web page that is the first content and the number of to items carried in the Web page are monitored. The numbers of accesses can be obtained by referring to, for example, an access log that records accesses.

### 2. Updating Process and Creating Process of Content

The first content on which accesses concentrate is updated to the second content, or the second content is created by extracting particular content from the second content. In this case, the second content may describe the items on which accesses concentrate in the content currently present.

For updating and creation of the content, description will be given for updating of a Web page and creation of a new Web page.

### 2. 1. Case Where New Web Page Including Other Items Is Created (FIG. 3)

As depicted in (A) of FIG. 3, a Web page “A” as the first content includes items A1, A2, . . . , An. The items A1, A2, . . . , An are the particular content portion of the first content. Representing the number of accesses to the Web page A as “Na”, the number Na of accesses is reaching the maximal page access number Nm when the item A1 is dominant in the number Na of accesses.

In this context, as depicted in (B) of FIG. 3, the Web page A is updated to a Web page A′ as the second content by deleting the item A1 that is the particular content portion from the Web page A, and a Web page B is created from the Web page A as the second content including the item A1. The Web page B includes other items B1, B2, . . . , Bn. The updating of the Web page A to the Web page A′ and the creation of the Web page B may be executed simultaneously or may be executed providing a time lag therebetween.

As above, when the Web page A is updated to the Web page A′, the item A1 that is the cause of the majority of accesses is deleted and, thereby, the number Na of accesses is reduced to a number Na′ (<Na) of accesses. The item A1 is added to the new Web page B and this page has the number Nb of accesses. As a result, the number of accesses is dispersed to the Web page A′ and the Web page B and the load on the server apparatus 4 is alleviated. Therefore, expedition of responses to the client apparatuses 61, 62, 63, . . . , 6N that are accessing is facilitated. The Web page B that is added with the item A1 has new accesses thereto and the new accesses provide opportunities of advertisement and purchase for the items B1 to Bn.

In this case, when a state where the number Nb of accesses to the Web page B is reaching the maximal page access number Nm is established, the Web page B may be the first content and another Web page that is the second content may be created. Similarly, dispersion of the number of accesses and deployment of a large number of Web pages are enabled.

### 2. 2. Case Where New Web Page Not Including Other Items Is Created (FIG. 4)

A form has been described in the section 2. 1, according to which the Web page B is created and the item A1 that is the particular content portion is carried therein being mixed with the other items B1 to Bn. However, another configuration may be employed according to which the Web page A is updated to the Web page A′ as the second content by excluding the item A1 from the Web page A and a Web page C only including the item A1 is created as the second content, as depicted in (A) and (B) in FIG. 4.

Even when this configuration is employed, similarly, the number Na of accesses to the Web page A can be reduced to Na′ (<Na). In this case, the Web page C has the number Nc of accesses thereto. In this case, similarly, the number of accesses is dispersed to the Web page A′ and Web page C and the load on the server apparatus 4 is alleviated. Therefore, expedition of responses to the client apparatuses 61, 62, 63, . . . , 6N that are accessing can be facilitated.

As to the Web page C, even when the number Nc of accesses reaches the maximal page access number Nm, the load on the server apparatus 4 for an individual page only including the item A1 is not so heavy and the expedition of the responses to the client apparatuses 61, 62, 63, . . . , 6N that are accessing is not hindered.

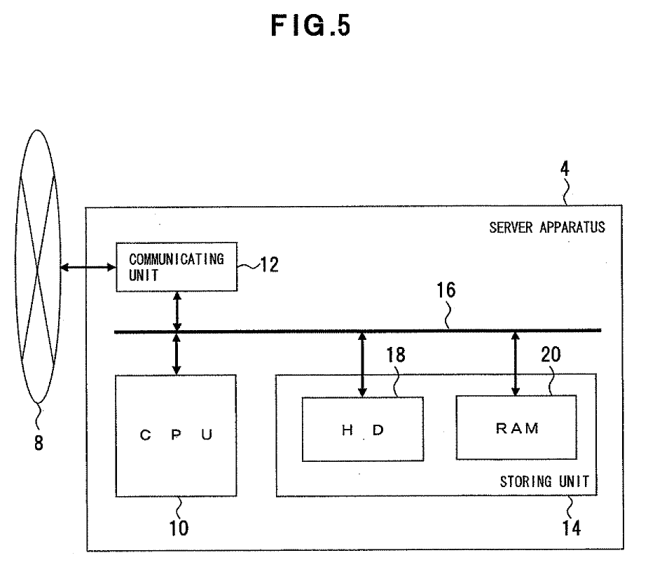

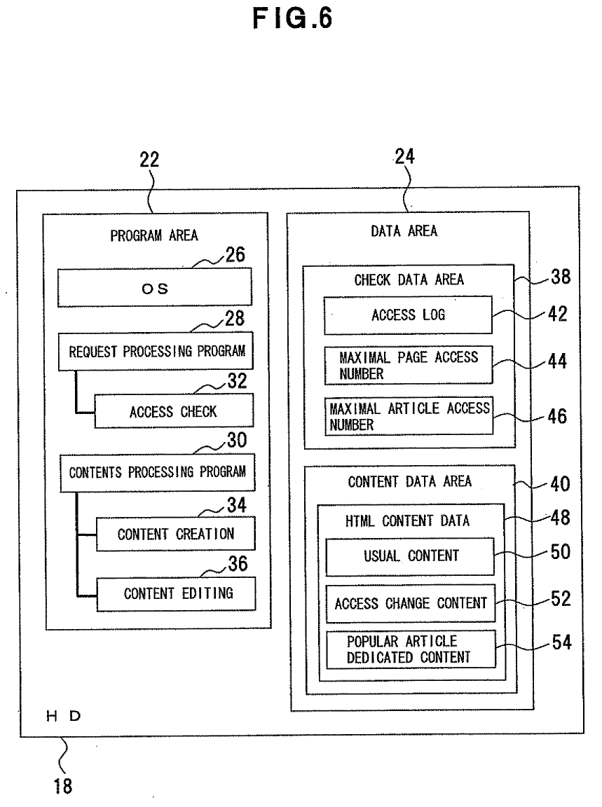

Description will be given for the server apparatus 4 referring to FIGS. 5 and 6. FIG. 5 depicts a block diagram of an exemplary server apparatus. FIG. 6 depicts exemplary stored content in a hard disk apparatus in a storing unit. In FIG. 5, same reference numerals are respectively given to the same components in FIG. 1.

The server apparatus 4 used for the above server system 2 and the content processing method is a computer having a communication function and includes a CPU (Central Processing Unit) 10, a communicating unit 12, and a storing unit 14 that are connected by a bus 16.

The CPU 10: is a processing unit that executes content processing, etc.; configures a monitoring unit that monitors accesses; executes an operating system (OS) stored in the storing unit 14; executes a content processing program, a request processing program, other programs, etc.; has functions of creating and editing content as described below; and executes reading and writing of data from/into the storing unit 14 and control of the communicating unit 12.

The communicating unit 12 is connected to the client apparatuses 61, 62, 63, . . . , 6N through the network 8, is controlled by the CPU 10, and is responsible for transmission and reception of various types of data to/from the client apparatuses 61, 62, 63, . . . , 6N. More specifically, the communicating unit 12 accepts requests from the client apparatuses 61, 62, 63, . . . , 6N and responds to the requests. The response results are transmitted to the client apparatuses 61, 62, 63, . . . , 6N through the communicating unit 12. The communicating unit 12 may have a configuration that enables the unit 12 to connect to the network 8 by not only wired connection but also radio connection using radio signals.

The storing unit 14 includes: as a recording medium that stores various programs and data, for example, a hard disk apparatus (RD) 18; and a RAM (Random-Access Memory) 20 used as a working area. The storing unit 14 may be configured by recording mediums such as a flash memory and a non-volatile memory instead of the HD 18 and the RAM 20.

As depicted in FIG. 6, a program area 22, a data area 24, etc., are set in the HD 18. The program area 22 stores an OS 26, a request processing program 28, and a content processing program 30. The request processing program 28 accepts and scrutinizes the client apparatuses 61, 62, . . . , 6N and executes the response processes thereto, etc. The request processing program 28 includes an access check program 32. The access check program 32 checks the number of accesses to Web pages and the number of accesses to items in the web pages.

The content processing program 30 executes the above content processing. The content processing program 30 includes a content creating program 34, a content editing program 36, etc. The content creating program 34 is used to create Web pages that is the first content and, for example, is used to create the Web page A (FIGS. 3 and 4), the Web page B (FIG. 3), the Web page C (FIG. 4), etc. The content editing program 36 is used for various editing processes such as change and division of content and, for example, is used for editing from the Web page A (FIGS. 3 and 4) to the Web page A′ (FIGS. 3 and 4), etc.

A check data area 38 and a content data area 40 are set in the data area 24. An access log 42, the maximal page access number 44, the maximal article access number 46, etc., are set in the check data area 38. The content data area 40 stores, for example, an HTML content data 48 that represents articles, etc. The content data 48 stores various types of content data such as usual content 50, access change content 52, popular article dedicated content 54, etc.

The server apparatus 4 monitors concentration of accesses to Web pages and items thereof in Web sites and the trend of the concentration from information such as the number of accesses of the client apparatuses 61, 62, . . . , 6N while processes requests received by the communicating unit 12, and dynamically executes updating and creation of content, etc., corresponding to the state of the load. That is, the server apparatus 4 executes processes such as creating Web pages that disperse accesses corresponding to the state of the concentration and exchange the created pages with Web pages that are provided usually, etc.

In the server apparatus 4, the storing unit 14 stores, in addition to the content of the content and the Web pages that are displayed usually, the names of articles being up on the Web site and the description thereof, content data described in the HTML format that constitute the various programs, etc., templates to configure the pages and various types of other processing information. On the RAM 20, the OS 26 and the content processing program 30 are loaded and operations such as monitoring of the access state and creation of content are executed.

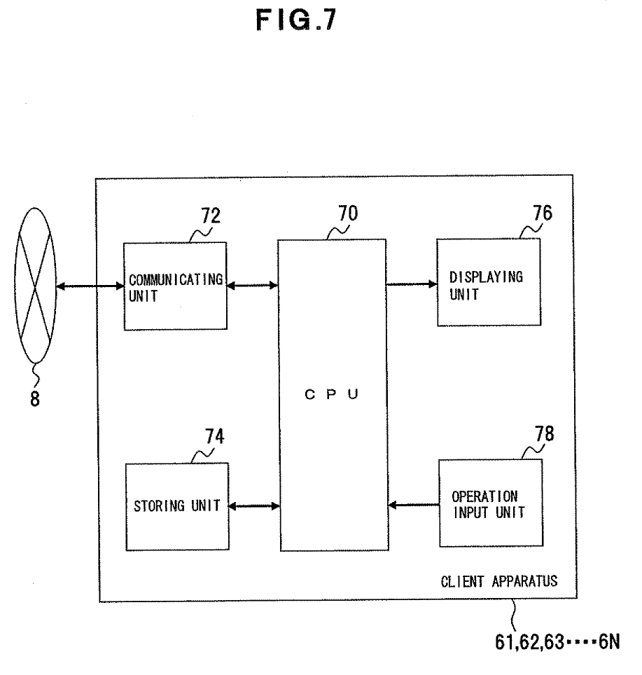

Description will be given for the client apparatuses 61, 62, . . . , 6N referring to FIG. 7. FIG. 7 depicts a block diagram of an exemplary client apparatus. In FIG. 7, same reference numerals are respectively given to the same components in FIG. 1.

Each of the client apparatuses 61, 62, . . . , 6N used in the server system 2 may be a computer connected to the network 8 and having a communicating function that can send requests to the server apparatus 4 and receive provision of content from the server apparatus 4, and the configuration thereof may be any of a PC, a PDA, and a portable telephone terminal apparatus as above.

As depicted in FIG. 7, each of the client apparatuses 61, 62, . . . , 6N is configured by a CPU 70, a communicating unit 72, a recording unit 74, a displaying unit 76 and an operation input unit 78.

The CPU 70 is a processing unit that executes processing of accesses and requests to receive provision of content from the server apparatus 4, processing to deploy visibly the content of Web pages into images, etc. based on execution of the OS and the processing programs stored in the storing unit 74, and executes control to other functional units and calculation processes to receive the provision of content. The communicating unit 72 is connected to the network 8 and, according to the control of the CPU 70, transmits requests, etc., and receives provision of various types of pieces of information from the server apparatus 4. Similarly to the above communicating unit 12, the communicating unit 72 is connected to the network 8 by wired connection using telephone lines, optical fibers, etc., and, may also be connected by wireless connection using wireless signals through wireless LANs (Local Area Networks), etc.

The storing unit 74 is configured by a ROM, a RAM, and various types of memories and, as a storing area, stores various programs such as programs to make connection to the OS and the network 8, a browser to view Web sites (a viewer program), etc. The RAM is used for various types of calculations and execution processes of programs as a working area.

The displaying unit 76 is configured by, for example, an LCD (Liquid Crystal Display) and outputs display information such as Web pages provided from Web sites as images.

The operation input unit 78 is used for inputting information such as inputting addresses to connect to Web sites such as, for example, URLs (Uniform Resource Locators), and inputting into dialog screens in the Web pages provided, and is configured by, for example, a keyboard or a mouse.

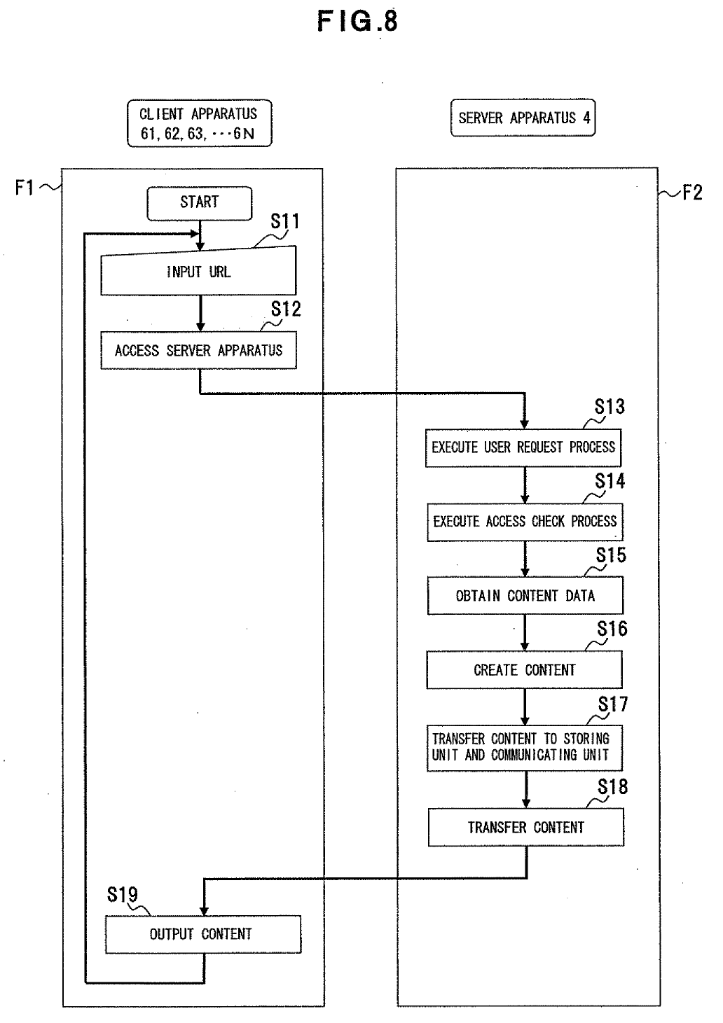

Description will be given for system processing of the server system 2 referring to FIG. 8. FIG. 8 depicts a flowchart concerning a process procedure of the server system.

The system processing includes processing by the clients (F1) such as reception of accesses and content from the client apparatuses 61, 62, . . . , 6N and processing by the server (F2) such as content processing by the server apparatus 4. The processing by the server apparatus 4 includes monitoring of the number of accesses to Web sites, determination of the load on the server apparatus 4 based on the trend of concentration of the accesses, creation of pages of which the content to be provided is changed corresponding to the state of the load, etc., exchanging the changed pages with the content to be displayed usually, and providing the exchanged pages to the client apparatuses.

A URL to specify a Web site of the server apparatus 4 is inputted into an input screen displayed on the displaying unit 76 of each of the client apparatuses 61, 62, . . . , 6N (step S11). When this input process is executed by each of the client apparatuses 61, 62, . . . , 6N, an access is made to the server apparatus 4 through the network 8 (step S12).

When a request made by the above access is accepted, the server apparatus 4 executes a user request process (step S13). That is, a user request, etc., are transmitted requesting a dynamic process such as content (for example, execution of a Web program, etc.) from each of the client apparatuses 61, 62, . . . , 6N to the server apparatus 4. In response to this, for accesses and requests from the client apparatuses, the server apparatus 4 executes the user request process such as execution of various programs and preparation for providing content to the client apparatuses, and executes an access check process using the current number of accesses to the Web sites (step S14) and executes processes such as determination of the load on the server apparatus 4.

The access check is to monitor the access log 42 to the communicating unit 12. In this case, the monitoring means to monitor accesses to Web pages, accesses to items in the Web pages, etc. That is, the access check means to execute an access check for not only accesses to the whole Web site but also each page carrying content and each piece of content carried, for example, each article. The distribution of the number of accesses to individual items such as articles is helpful to know the trend of accesses to the Web page and is helpful information to cerate new content.

The access check judges for each page on a Web site and the content carried in the page whether the number of accesses from the client apparatuses has reached a predetermined limit value. To create pages to facilitate dispersion of accesses in response to the judgment result, using the content processing program 30, after setting the content of the content, the configuration of the pages, etc., the content data 48 is obtained from the storing unit 14 (step S15). The content data 48 is obtained from the data area 24 of the storing unit 14 as above and may also be obtained from a database, etc., provided outside the server apparatus 4.

The content program 34 is executed and a Web page is created as content using the content data 48 obtained (step S16). The created content is stored in the storing unit 14 and is transferred to the communicating unit 12 (step S17), and the Web pages are transferred to each of the client apparatuses 61, 62, . . . , 6N that has issued the requests (step S18). Each of the client apparatuses 61, 62, . . . , 6N converts the content transferred from the server apparatus 4 in the HTML format into a viewable form using a viewing program and outputs the converted content to the displaying unit 76 (step S19). As a result, the user can view the content obtained and can purchase articles and can obtain new article information.

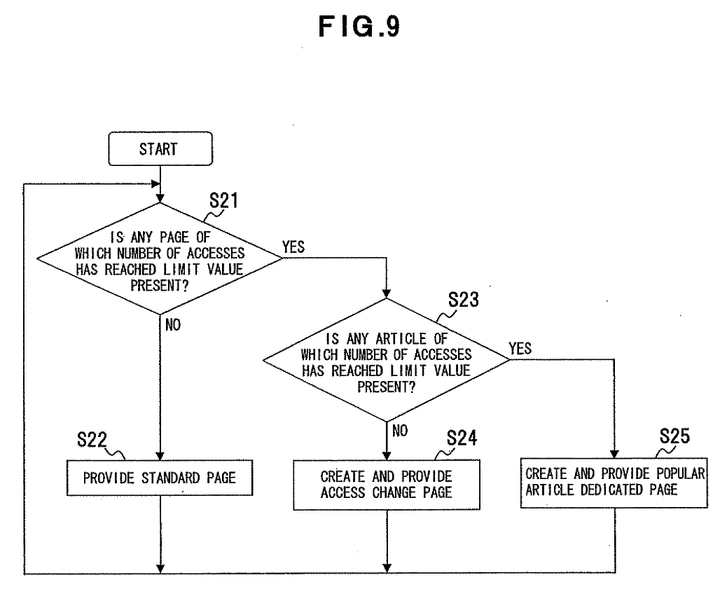

Description will be given for the content processing of the server apparatus 4 referring to FIG. 9. FIG. 9 depicts a flowchart of an exemplary process procedure of a content processing method and a content processing program.

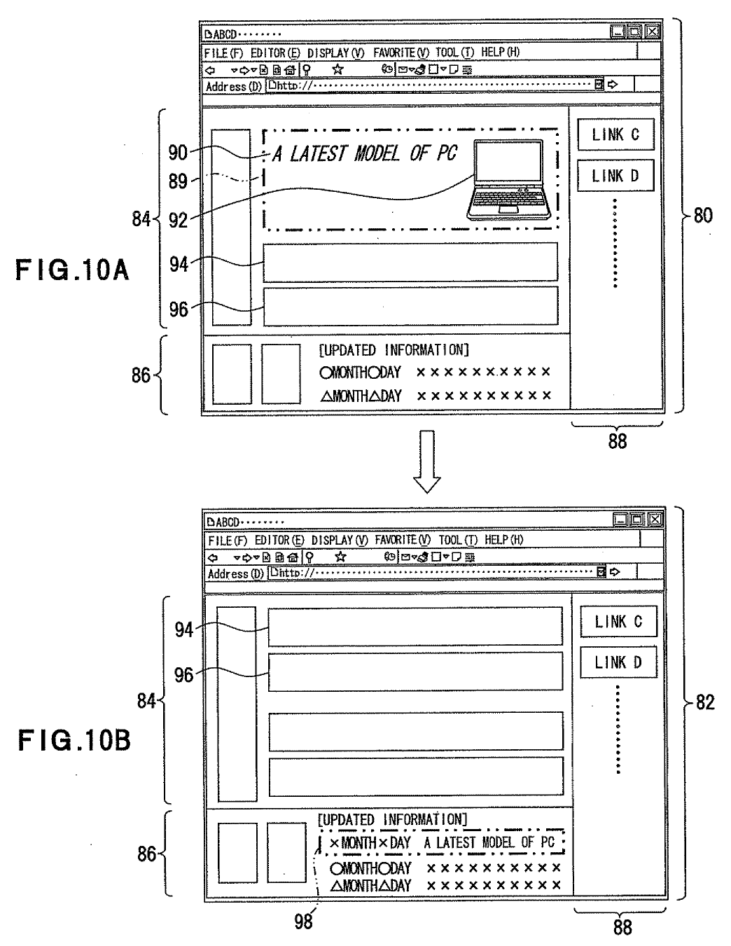

The server apparatus 4 receiving accesses from the plurality of client apparatuses 61, 62, . . . , 6N monitors concentration of the accesses, executes a page access judgment as a judgment in the first stage, and monitors the number of requests for each page. More specifically, the server apparatus 4 judges whether any Web page of which the number of accesses thereto has reached the limit value is present (step S21). When the number of accesses has not reached the limit value (NO of step S21), the current state of the pages can be maintained. That is, the server apparatus 4 maintains the provision of the Web page (FIG. 10A) that is a standard page (step 522) and the procedure returns to step S21. Thereby, access check is executed continuously.

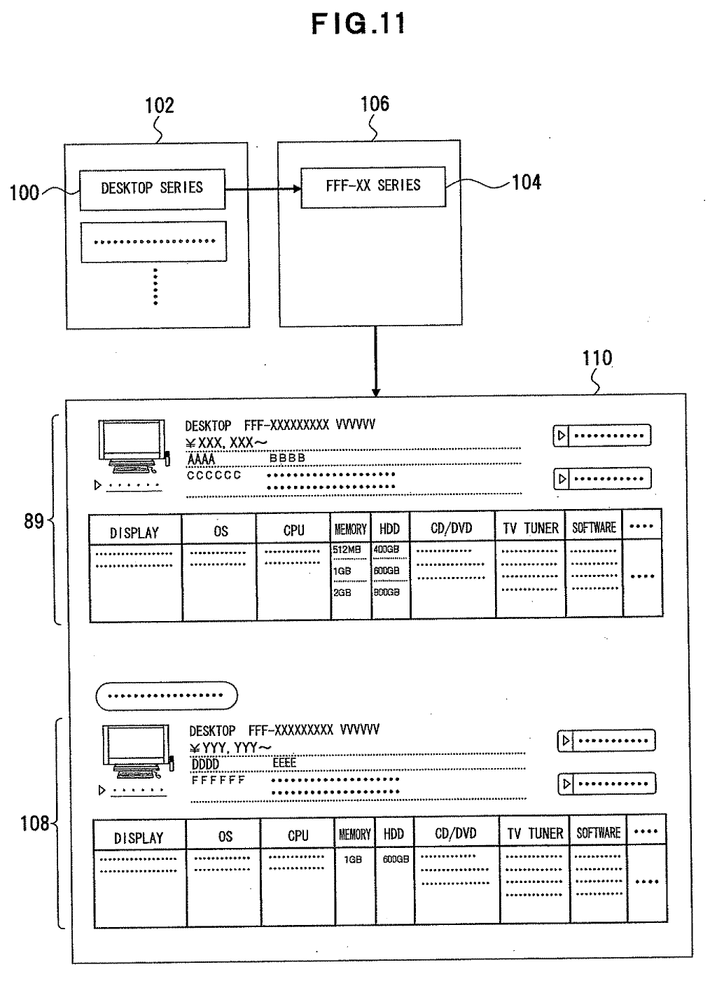

During the check of the number of accesses for each page (step S21), when a page of which the number of accesses thereto has reached the limit value is present (YES of step S21), in the Web page (FIG. 10A) that is a standard page, the server apparatus 4 executes an article access judgment as judgment in the second stage and monitors the number of requests for each article. More specifically, the server apparatus 4 judges whether any item, that is, article of which the number of accesses thereto has reached the limit value is present (step S23). When no article of which the number of accesses thereto has reached the limit value is present (NO of step $23), as a process to enhance the guidance to Web pages of which the number of accesses is a few (not popular), the server apparatus 4 creates and provides a Web page (FIG. 10B) as the second content created by updating the Web page that is a standard page and guides accesses to the created page (step S24). In this case, the creation of the Web page as the second content may be creation of the Web page by combining popular items and other items (FIG. 11).

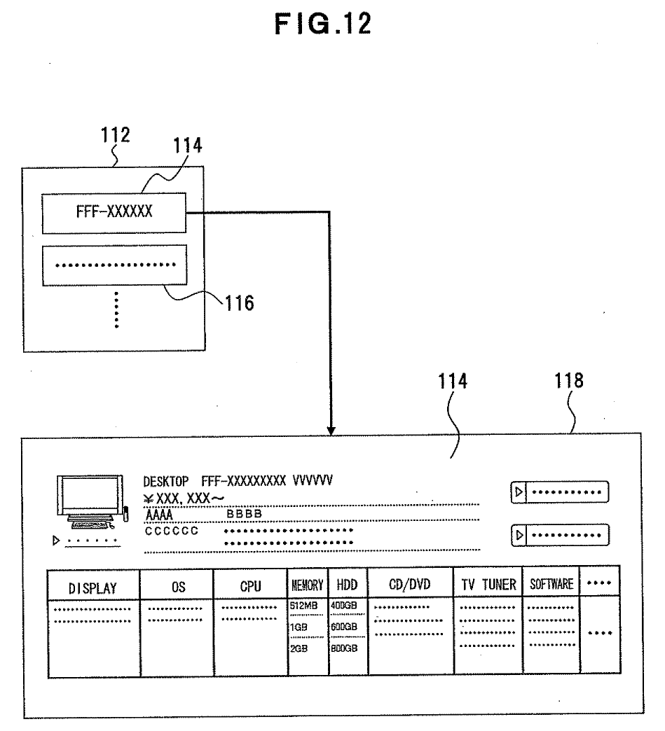

When any article of which the number of accesses has reached the limit value is present at step S23 (YES of step S23), the server apparatus 4 creates and provides a new Web page as the second content that carries articles extracted from the Web page that is a standard page, that is, popular article dedicated page (FIG. 12) (step S25).

For the above stepwise process of dispersing accesses, some specific articles will be referred to. For example, on a shopping site that links a plurality of pages using hyper links, accesses tend to concentrate on pages that carry featured articles and specific popular articles. In the page access judgment, the server apparatus 4 monitors the access log 42 for each of these pages and judges whether the number of accesses of the page has reached a predetermined limit value. As the result of the judgment, when no page of which the number of accesses thereto has reached the limit value is present, the server apparatus 4 provides the standard page that has been created in advance and stored in the data area 24 as a data storing unit of the storing unit 14, in response to accesses from the client apparatuses.

When a Web page of which the number of accesses thereto has reached the limit value is present, the server apparatus 4 checks the access log 42 for each article as article access judgment for a content portion carried in the page, for example, an article carried in the page, and judges whether any article of which the number of accesses thereto has reached the limit value is present. As the result of the judgment, when no article of which the number of accesses thereto has reached the limit value is present, the server apparatus 4 creates a Web page by updating the content of the Web page and exchange the created page with the standard page as a process to stop the increase of the number of accesses to the Web page.

When an article of which the number of accesses thereto has reached the limit value is present, that is, when accesses concentrate on a particular article, the server apparatus 4 judges the article as a popular article, reads the content data 48 concerning the article from the storing unit 14, creates a new popular article dedicated page for the popular article, and creates and provides a Web page carrying the popular article together with other articles. In this case, a configuration may be employed according to which, for the original standard page, after creating the popular article dedicated page, the new page is provided through display of a link thereto displayed in the standard page that carries no popular article.

Description will be given for updating or creation of a Web page referring to FIGS. 10A, 10B, 11, and 12. FIGS. 10A and 10B depict a standard page and updating to a updated page thereof. FIG. 11 depicts creation of a Web page including popular articles from a Web page. FIG. 12 depicts creation of a popular article dedicated page from a Web page.

### 1) Updating from Standard Page to Updated Page (FIG. 10)

Referring to FIGS. 10A and 10B, FIG. 10A depicts the standard page as the first content and FIG. 10B depicts an updated page as the second content created by updating the standard page. A standard page 80 and a changed page 82 thereof both respond to accesses from the client apparatuses 61, 62, . . . , 6N and are video information representing a shopping site viewable by a Web browser.

Carrying areas 84, 86, and 88 carrying article information are formed in the standard page 80 and, in the embodiment, the carrying area 84 carries an article message 90 and an article photograph 92 appealing “The Latest Model of PC” are carried as an item 89 representing the article. The carrying area 86 carries updated information together with the date and the time of day. The carrying area 88 displays link destinations.

Assuming that accesses concentrate on the standard page 80 and the cause of the concentration is “The Latest Model of PC” as the item 89 in the carrying area 84, accesses to other items 94, 96, etc., in the carrying area 84 are influenced by the concentration of the accesses to “The Latest Model of PC”. More specifically, adverse influences such as slowing down and delay of responses from the server apparatus 4 may occur.

As depicted in FIG. 10B, the standard page 80 is updated to the changed page 82. In this changed page 82, the item 89 has been deleted from the carrying area 84 and has been changed to the other items 94 and 96, and information 98 corresponding to the item 89 that includes images or videos is displayed being shrunk as character information in the carrying area 86. That is, due to the deletion of the item 89 that is a popular article, accesses from the changed page 82 to the popular article are reduced. However, when the article is a popular article, move through the link to the Web page of the popular article is possible using the updated information thereof as a clue and, therefore, inconvenience such as impairment of shopping eagerness is not present.

By changing the display configuration and the disposing position of the guiding display such as a link destination display corresponding to the state of accesses from the client apparatuses, further increase of the number of accesses to pages on which accesses concentrate can be prevented and the load on the server apparatus 4 can be alleviated. The display of content becomes easier and the volume of each page is reduced and therefore, elongation of the time necessary for transfer to the client apparatuses can be prevented.

### 2) Creation of Web Page Including Popular Articles From Web Page (FIG. 11)

This is the case where, concerning the process of the above 1), for the item 89 in the standard page 80 that is the first content, a Web page carrying popular articles together with other items is created. In this case, as depicted in FIG. 11, an item 100 that is a super-ordinate concept encompassing the item 89 is carried in a Web page 102 and an item 104 that is a subordinate concept of the Web page 102 from the Web page 102 is carried in a Web page 106. These are in a linked relation. A Web page 110 that carries the item 89 together with another item 108 is formed. That is, the Web page 110 is a page formed by updating the original page by carrying the item 89. This process corresponds to the process depicted in FIG. 3.

The page content is also changed corresponding to the state of accesses from the client apparatuses by the above processing. Therefore, further increase of the number of accesses to the page on which accesses concentrate can be prevented and the load on the server apparatus 4 can be alleviated. The display of content can also be made easier and the page volume is reduced. Therefore, elongation of the time necessary for transfer to the client apparatuses can be prevented.

### 3) Creation of Popular Article Dedicated Page from Web Page (FIG. 12)

As depicted in FIG. 12, when accesses concentrate on an item 114 in a Web page 112, this concentration influences accesses to another item 116 and, therefore, the item 114 is deleted from the Web page 112 and a dedicated page 118 only carrying the item 114 is created.

When the dedicated page 118 has been created for the popular article with a large number of accesses, accesses are guided to the dedicated page 118 and the number of accesses to the Web page 112 can be reduced and dispersion of load can be facilitated.

In this case, accesses concentrate on the dedicated page 118. However, the load on the server apparatus 4 is reduced because the volume of the dedicated page 118 is reduced. The limit value used in the page access judgment executed after the creation of the popular article dedicated page 118 may be adjusted corresponding to the transfer capacity, etc., of the server apparatus 4.

### Second Embodiment

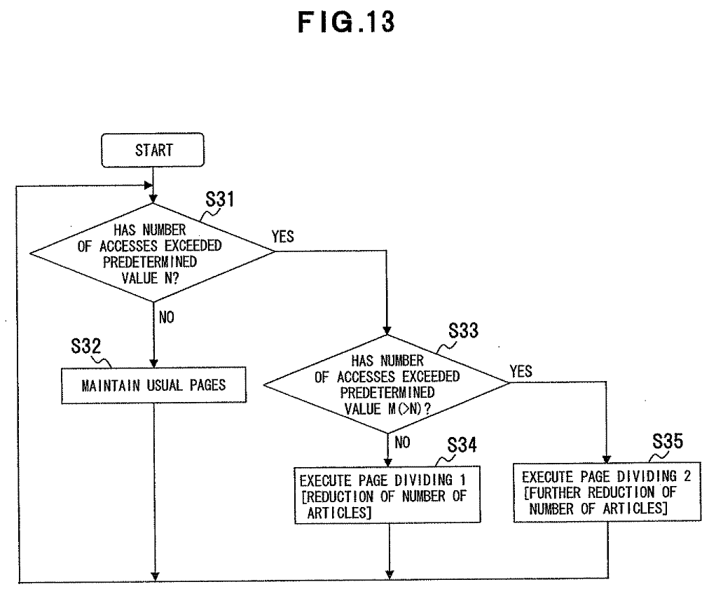

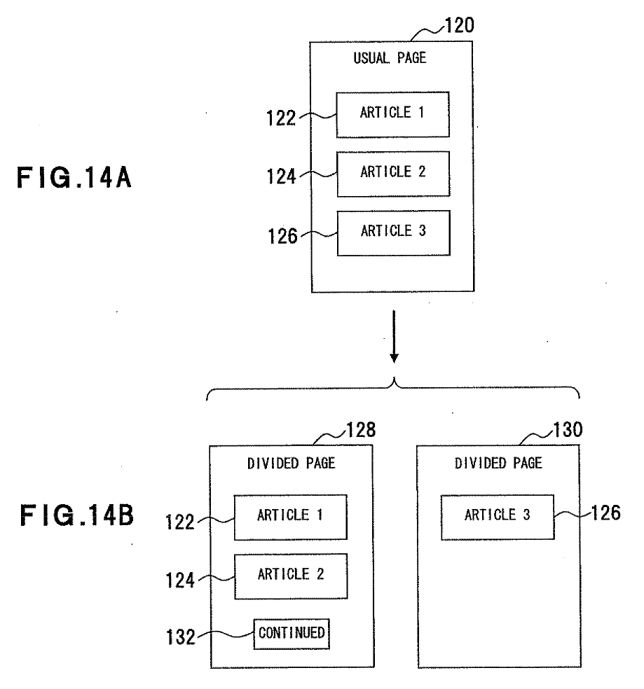

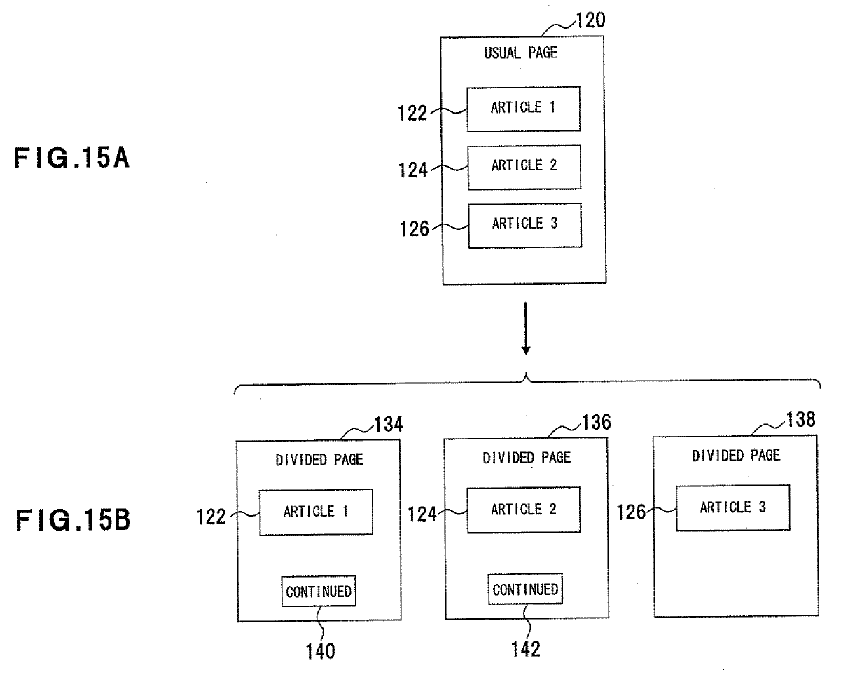

Description will be given for a second embodiment of the present invention referring to FIGS. 13, 14A, 14B, 15A, and 15B. FIG. 13 depicts a flowchart of an exemplary process procedure of a content processing method and a content processing program according to the second embodiment. FIGS. 14A, 14B, 15A, and 15B depict an exemplary content dividing process.

In the second embodiment, the same server system 2 (FIG. 1), the same content processing method (FIG. 2), the same server apparatus 4 (FIG. 5), the same HD 18 (FIG. 6), the same client apparatuses 61, 62, 63, . . . , 6N (FIG. 7), and the same process procedure of the server system (FIG. 8) are also used.

In the second embodiment, dispersion of the number of accesses is facilitated using a page dividing process coping with increase of the number of accesses. Whether the number of accesses has exceeded a predetermined value N is judged as a judgment of the load (step S31). When the number of accesses has not exceeded the predetermined value N (NO of step S31), usual pages are maintained (step S32) and the procedure returns to step S31 and the number of accesses is monitored.

When the number of accesses has exceeded the predetermined value N (YES of step S31), whether the number of accesses has exceeded another predetermined value M (>N) is judged (step S33). When the number of accesses is equal to or fewer than the predetermined value M, page dividing 1 that copes with the number of accesses that is larger than N and equal to or fewer than M is executed (step S34). When the number of accesses has exceeded the predetermined value M (YES of step S33), page dividing 2 that cope with the number of accesses that is equal to or larger than M is executed (step 335). In this case, the page dividing 2 employs a larger number of divisions than that of the page dividing 1, reduces the number of articles in a divided page in proportion to the increase of the number of accesses, and, thereby, facilitates reduction of the number of accesses to the page.

In the second embodiment, a light-load divided page is created and provided when an article for which the number of accesses has reached the limit value is present. Due to the creation of the above page, the concentration of accesses on a particular page can be avoided by reducing the number of articles therein.

According to the above process procedure, when the number of accesses are a few, a usual page 120 is presented as the first content as depicted in FIG. 14A. The usual page 120 carries three items 122, 124, and 126 including articles 1, 2, and 3.

When the number of accesses to the usual page 120 increases and the number of accesses has exceeded the predetermined value N, the usual page 120 is, for example, divided into a plurality of divided pages 128 and 130 as the second content as depicted in FIG. 14B and the divided pages 128 and 130 are presented. In the divided page 128: the item 126 is deleted from the three items 122, 124, and 126; the items are reduced to the items 122 and 124 that include the articles 1 and 2; and a link button 132 with “Continued” indicated thereon is displayed to move to the divided page 130. In the divided page 130, the item 126 representing the article 3 is displayed.

Because the usual page 120 is divided into the plurality of divided pages 128 and 130 as above, the number of accesses to the usual page 120 is divided into those of the divided pages 128 and 130 and alleviation of the load on the server apparatus 4 can be facilitated.

When the number of accesses has further increased and the increased number of accesses has exceeded the predetermined number M (>N), divided pages may be increased. For example, as depicted in FIGS. 15A and 15B: the usual page 120 as the first content is divided into divided pages 134, 136, and 138; these divided pages 134, 136, and 138 are formed respectively for the items 122, 124, and 126 in the usual page 120; and link buttons 140 and 142 to move to the next pages thereof are displayed respectively in the divided pages 134 and 136, and the group relation among the items 122, 124, and 126 is maintained.

By increasing the number of divided pages corresponding to the rapid increase and the trend of the increase of the number of accesses to the usual page 120 in this manner, individual number of accesses to each of the items 122, 124, and 126 can be coped with and alleviation of the load associated with increase of the number of accesses can be facilitated.

### Third Embodiment

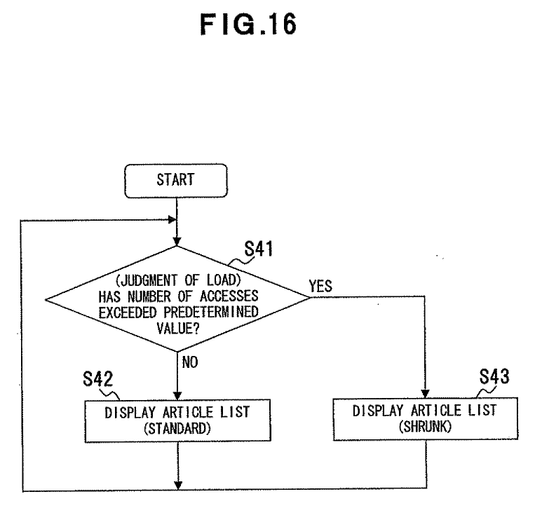

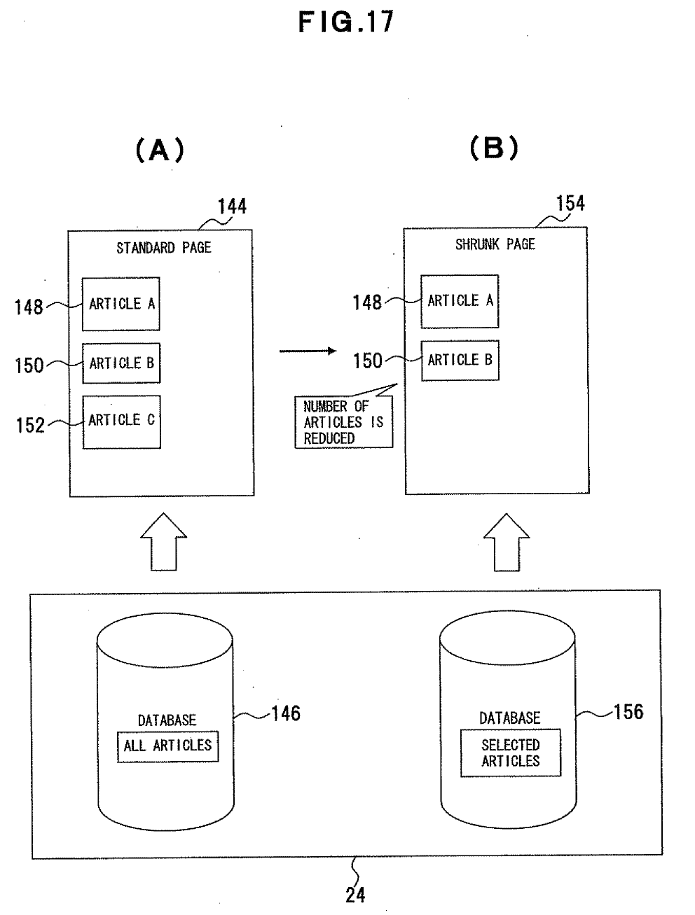

Description will be given for a third embodiment of the present invention referring to FIGS. 16 and 17. FIG. 16 depicts a flowchart of an exemplary process procedure of a content processing method and a content processing program according to the third embodiment. FIG. 17 depicts exemplary content processing. In FIG. 17, same reference numerals are respectively given to the same components in FIG. 6.

In the embodiment, a process is executed according to which the number of articles to be carried in an article list display is reduced with increase of the number of accesses and concentration of accesses is alleviated. In the embodiment, the same server system 2 (FIG. 1), the same content processing method (FIG. 2), the same server apparatus 4 (FIG. 5), the same HD 18 (FIG. 6), the same client apparatuses 61, 62, 63, . . . , 6N (FIG. 7), and the same process procedure of the server system (FIG. 8) are also used.

In the embodiment, as depicted in FIG. 16, whether the number of accesses has exceeded a predetermined value is judged as a judgment of the load (step S41). When the number of accesses has not exceeded the predetermined value (NO of step S41), a standard page is created as an article list display (step S42). When the number of accesses has exceeded the predetermined value (YES of step S41), a shrunk page is created coping with the concentration of the accesses (step S43). A reduced number of articles compared to that of the standard page are presented in the shrunk page. In this case, when the number of accesses is reduced, the standard page is restored coping with the trend of the reduction.

As to the above process, usually, as depicted in (A) of FIG. 17, a database 146 corresponding to the standard page 144 is constructed in the data area 24 of the storing unit 14 and the database 146 stores the data of all articles. In this case, the standard page 144 discloses items 148, 150, and 152 representing a plurality of articles A, B, and C. Each of the articles A, B, and C represents an article group including a single article or a plurality of articles.

When the number of accesses has exceeded the predetermined value, as depicted in (B) of FIG. 17, a database 156 corresponding to the shrunk page 154 is constructed in the data area 24 of the storing unit 14 and the database 156 stores the data of a reduced number of articles from all the articles. In this case, whereas the standard page 144 discloses the items 148, 150, and 152 representing the plurality of articles A, B, and C, the shrunk page 154 discloses the items 148 and 150 including the articles A and B. As above, the standard page 144 and the shrunk page 154 have page configurations that include common content.

As above, by moving accesses from the standard page 144 to the shrunk page 154 and constructing the databases 146 and 156 corresponding respectively to the configurations of those pages with the increase of the number of accesses, and by forming the databases 146 and 156 coping with the trend of accesses, a page can be created dynamically corresponding to the number of accesses and the concentration of accesses can be avoided.

### Fourth Embodiment

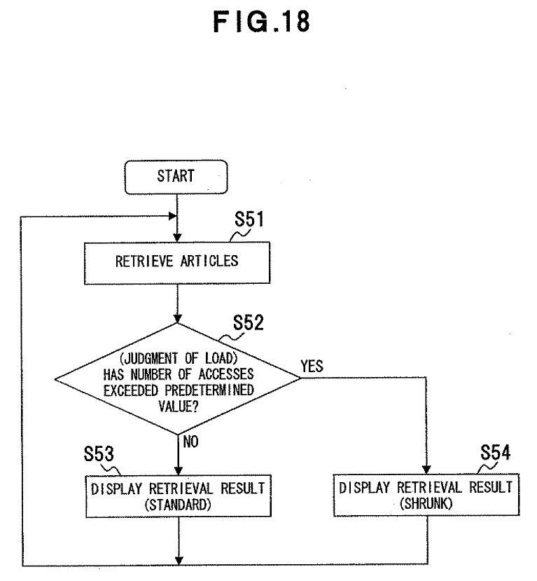

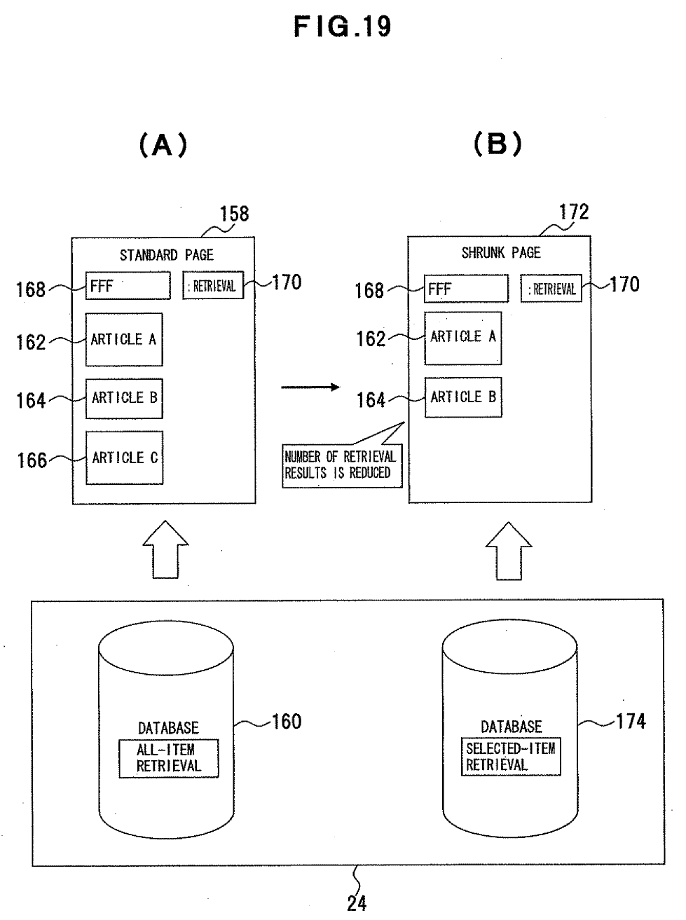

Description will be given for a fourth embodiment of the present invention referring to FIGS. 18 and 19. FIG. 18 depicts a flowchart of an exemplary process procedure of a content processing method and a content processing program according to the fourth embodiment. FIG. 19 depicts exemplary content processing for article retrieval. In FIG. 19, same reference numerals are respectively given to the same components in FIG. 6.

In the embodiment, a process is executed according to which, with the increase of the number of accesses, the number of articles to be carried in the article list display as the result of retrieval associated with the article retrieval is reduced and concentration of accesses is alleviated. In the embodiment, the same server system 2 (FIG. 1), the same content processing method (FIG. 2), the same server apparatus 4 (FIG. 5), the same HD 18 (FIG. 6), the same client apparatuses 61, 62, 63, . . . , 6N (FIG. 7), and the same process procedure of the server system (FIG. 8) are also used.

The embodiment provides a process for the case where article retrieval is executed as a content process. When the article retrieval (step S51) is executed, whether the number of accesses for retrieval has exceeded a predetermined value is judged as a judgment of the load (step S52). When the number of accesses has not exceeded the predetermined value (NO of step S52), a standard page is created and displayed as the retrieval result display (step S53). When the number of accesses has exceeded the predetermined value (YES of step S52), a shrunk page is formed and displayed as the retrieval result display (step S54). In this case, similarly, the standard page presents all the articles as a standard retrieval result and the shrunk page presents a fewer number of articles as a selected retrieval result. Thereby, the concentration of accesses can be dispersed in the retrieval stage.

As to the above retrieval process, usually, as depicted in (A) of FIG. 19, a database 160 corresponding to the standard page 158 displaying the retrieval result as the first content is constructed in the data area 24 of the storing unit 14 and the database 160 stores the data of all articles corresponding to all-article retrieval. In this case, the standard page 158 discloses items 162, 164, and 166 representing the plurality of articles A, B, and C and displays an item 168 representing an article group and a retrieval button 170. Each of the articles A, B, and C represents an article group including a single article or a plurality of articles.

When the number of accesses has exceeded the predetermined value, as depicted in (B) of FIG. 19, a database 174 corresponding to the shrunk page 172 as the second content is constructed in the data area 24 of the storing unit 14 and the database 174 stores the data of articles for which the articles to be retrieved is selected. In this case, whereas the standard page 158 discloses the items 162, 164, and 166 representing the plurality of articles Ar B, and C, the shrunk page 172 discloses the items 162 and 164 including the articles A and B. As above, the standard page 158 and the shrunk page 172 have page configurations that include common content.

As above, concerning the article retrieval, by moving accesses from the standard page 158 to the shrunk page 172 and constructing the databases 160 and 174 corresponding respectively to the configurations of those pages with the increase of the number of accesses, and by forming the databases 160 and 174 corresponding to the trend of accesses, a page can be created dynamically coping with the number of accesses and the concentration of accesses can be avoided in the retrieval stage.

### Other Embodiments

(1) For the above embodiments, the second content created for the first content on which accesses concentrate may be content including only content created by excluding a particular content portion of the first content (for example, (B) of FIG. 3), may be content created by changing the particular content portion, and may be content created by adding other content after excluding the particular content portion (for example, FIG. 10B).

(2) In the above embodiments, as the judgment of the load on the server apparatus 4, the degree of concentration of accesses is judged from the access logs. However, in addition to this, for example, a configuration may be employed according to which the judgment of the load is executed based on the operating rate of the CPU 10, use rate of the RAM, etc., the transferred amount, etc., of the server apparatus 4.

(3) For the above embodiments, when a plurality of popular articles each receiving a large number of accesses are present, for example, a dedicated page is created for each popular article. However, in addition to this, for example: judgments may be made on the volume of the content of the popular articles, the number of accesses from the client apparatuses, the processing capacity of the server apparatus 4, the transfer capacity of the communicating unit 12, etc.; the load on the server apparatus 4 may be considered from the judgment results; pages each carrying several of the popular articles may be created; and the created pages may be exchanged with the article pages. Thereby, no dedicated page is created for each popular article and many pages are not increased newly. Therefore, increase and complication of the processing by the server apparatus 4 can be prevented and over-loading on the server apparatus 4 can be prevented.

(4) In the above embodiments, in the judgment of accesses to articles, the current number of accesses from the client apparatuses is used as the judgment criterion. However, in addition to this, for example, the past actual number of sold articles, etc., may be stored in the storing unit 14 and this value may be added to the judgment criterion and the judgment may be executed. Otherwise, the server apparatus 4 and the program therefor may employ a procedure according to which articles receiving a large number of accesses are estimated from information such as the past actual number of sold articles, information of the prices being set, day of the week, etc., and these pieces of information are stored in the storing unit 14. Concerning the articles judged under these conditions, it can be estimated in advance that the number of accesses to the articles will increase. Therefore, coping with the load on the server apparatus 4 before the load becomes heavy is enabled and the limit value for the article access judgment may be set to be low.

(5) In the above embodiments, the article access judgment is executed after the page access judgment is executed. However, in addition to this, for example, the article access judgment may be executed first. Thereby, for example, when a plurality of pages need to be passed through to access a page that carries a popular article, a page access judgment is executed on each of those pages and concentration of accesses can be prevented without creating an access change page. That is, popular articles that cause accesses to concentrate on each page may be identified in advance and other pages may be created.

The case may also be present where the number of accesses to a component (for example, each article) of a particular page has reached the limit value according to the article access judgment, however, the number of accesses to the page has not reached the limit value used for the page access judgment, depending on the method of taking the limit value for the access judgment. In this case, when the fact that the accesses are excessive for the component (the article) is identified in advance, the load on the server apparatus 4 can be identified sooner.

(6) In the above embodiments, the CPU 10 of the server apparatus 4 newly creates content corresponding to the results of the access judgments. In addition, the CPU 10 may prepare in advance the second content to be updated, may store the second content in the storing unit 14, and may select and update the second content corresponding to the results of the access judgments.

Though the description has been given for the preferred embodiments of the present invention as above, the above description do not limit the present invention. Those skilled in the art can surely make various modifications and changes to the present invention based on the purview of the present invention described in claims or disclosed in the preferred embodiments for implementing the present invention. The modifications and changes are surely encompassed in the scope of the present invention.

As above, the present invention is useful as a server apparatus that receives accesses from a plurality of client apparatuses and provides information corresponding to the accesses, creates second content correlated with first content on which accesses concentrate and facilitates dispersion of concentration of accesses and, therefore, the load on the server apparatus can be alleviated by the dispersion of the accesses and the processing thereof can be eased, etc.

What is claimed is:

1. A server apparatus that receives accesses from a plurality of client apparatuses and responds to the accesses, comprising
a processing unit that monitors accesses from the client apparatuses and, in case where accesses concentrate on first content, creates second content for the first content, the second content being correlated with first content, wherein
the server apparatus disperses the accesses that concentrate on the first content to the second content.

2. The server apparatus of claim 1, wherein
the second content is content consisting only of a particular content portion of the first content, content including the particular content portion, or content excluding the particular content portion.

3. The server apparatus of claim 2, wherein
the content portion in the second content is changed into a form that is different from the first content.

4. The server apparatus of claim 1, wherein
the processing unit has a function of creating and/or editing the first content and/or the second content.

5. The server apparatus of claim 1, wherein
the second content includes a particular content portion divided from the first content.

6. The server apparatus of claim 1, wherein
the second content displays using character information a content portion including image included in the first content.

7. The server apparatus of claim 1, wherein
the second content shrinks and displays a particular content portion included in the first content.

8. The server apparatus of claim 1, wherein
the processing unit monitors concentration of accesses on or the trend of accesses to one or more content portion(s) included in the first content, extracts a content portion on which accesses highly concentrate, and creates the second content including the extracted content portion.

9. The server apparatus of claim 1, wherein
the first content and/or the second content include character information and/or video information.

10. The server apparatus of claim 1, wherein
the first content and/or the second content are display information for the client apparatuses.

11. The server apparatus of claim 1, wherein
the processing unit comprises a storing unit that stores the plurality pieces of second contents prepared in advance and selects the second content from the storing unit.

12. A content processing method for a server apparatus that receives accesses from a plurality of client apparatuses and responds to the accesses,
the method comprising the steps of:
monitoring accesses of the client apparatuses; and
in case where accesses concentrate on first content, creating second content correlated with the first content.

13. The content processing method for a server apparatus of claim 12, further comprising the step of
changing the second content to a form that is different from that of the first content.

14. The content processing method for a server apparatus of claim 12, wherein
processing of the second content comprises the step of creating shrunk display information of a particular content portion included in the first content.

15. The content processing method for a server apparatus of claim 12, further comprising the steps of:
monitoring concentration of accesses on or the trend of accesses to one or more content portion(s) included in the first content;
extracting a content portion on which accesses highly concentrate; and
creating the second content including the extracted content portion.

16. The content processing method for a server apparatus of claim 12, further comprising the steps of:
preparing in advance the plurality pieces of second contents; and
selecting the second content.

17. A content processing program that is executed by a computer and is for a server apparatus that receives accesses from a plurality of client apparatuses and responds to the accesses, the program comprising the steps of:
monitoring accesses of the client apparatuses; and
in case where accesses concentrate on first content, creating second content correlated with the first content.

18. The content processing program for a server apparatus of claim 17, further comprising the step of
changing the second content to a form that is different from that of the first content.

19. The content processing program for a server apparatus of claim 17, wherein
processing of the second content comprises the step of creating shrunk display information of a particular content portion included in the first content.

20. The content processing program for a server apparatus of claim 17, further comprising the steps of:
monitoring concentration of accesses on or the trend of accesses to one or more content portion(s) included in the first content;
extracting a content portion on which accesses highly concentrate; and
creating the second content including the extracted content portion.

21. The content processing program for a server apparatus of claim 17, further comprising the steps of:
preparing in advance the plurality pieces of second contents; and
selecting the second content.

22. A server system including a server apparatus that receives accesses from a plurality of client apparatuses and responds to the accesses, the system comprising
a server apparatus comprising a processing unit that monitors accesses from the client apparatuses and, in case where accesses concentrate on first content, creates second content correlated with the first content, the server apparatus dispersing the accesses that concentrate on the first content to the second content.

23. The server system of claim 22, wherein
the server apparatus monitors concentration of accesses on or the trend of accesses to one or more content portion(s) included in the first content, extracts a content portion on which accesses highly concentrate, and creates the second content including the extracted content portion.

24. A computer-readable recording medium having thereon stored a content processing program for a server apparatus that receives accesses from a plurality of client apparatuses and responds to the accesses, the program comprising the steps of:
monitoring accesses of the client apparatuses; and
in case where accesses concentrate on first content, creating second content for the first content, the second content being correlated with the first content.
